(19) United States
(12) Patent Application Publication
(10) Pub. No.: US 2025/0128988 A1
(43) Pub. Date: Apr. 24, 2025

(54) SELF-LUMINOUS PORTLAND CEMENT CONCRETE

(71) Applicant: THE AMERICAN UNIVERSITY IN CAIRO, New Cairo (EG)

(72) Inventors: Fatma ELNEFALY, Cairo (EG); Mayar KHAIRY, Cairo (EG); Mennatallah SOLIMAN, Cairo (EG); Zeinab AHMED, Cairo (EG); Mohamed Nagib ABOU-ZEID, Cairo (EG)

(73) Assignee: THE AMERICAN UNIVERSITY IN CAIRO, New Cairo (EG)

(21) Appl. No.: 18/925,744

(22) Filed: Oct. 24, 2024

Related U.S. Application Data
(60) Provisional application No. 63/592,785, filed on Oct. 24, 2023.

(51) Int. Cl. C04B 14/36; C04B 14/06; C04B 28/04; C04B 103/54; C04B 111/00; C04B 111/80; C09K 11/56

(52) U.S. Cl. CPC C04B 14/36; C04B 14/06; C04B 28/04; C09K 11/565; C04B 2103/54; C04B 2111/00482; C04B 2111/00663; C04B 2111/807

(57) ABSTRACT

A light-emitting concrete composition comprising a cement, such as Portland cement, coarse aggregates, fine aggregates, zinc sulfide, and water. A product, such as an architectural feature, comprising the light-emitting concrete and methods for formulating and mixing it as well as a dry mix suitable to which water can be added to produce the light-emitting concrete. Light-emitting concrete traps solar energy during the daytime and converts it into visible light at night. The light-emitting concrete disclosed herein emits soft light night without any electricity and contributes to energy conservation and low-carbon eco-friendly environment.

### BACKGROUND OF THE INVENTION

Field of the Invention. This disclosure falls within the field of materials science and engineering. Specifically, it pertains to a self-luminous concrete containing a phosphorescent compound or pigment like zinc sulfide (zinc sulphide, ZnS).

Description of Related Art. Self-luminous concrete contains materials that absorb and then emit light. It can be used in conditions where there is little ambient light or lamination or to provide an aesthetic appearance. It generally is composed of cement, aggregates such as gravel, sand, crushed stone, slag, recycled concrete, or geosynthetic polymers, and a material that emits light. It typically contains one or more photo-or electro-luminescent materials such as a phosphorescent, fluorescent, photoluminescent, or electroluminescent materials that emit light.

Previous work has demonstrated that self-luminous concrete can be obtained by adding luminous components to a concrete mix. However, work is needed to identify effective means for producing a self-luminous concrete with good physical properties including luminous performance and at a low cost. For example, various types of luminous concrete have been made including those of U.S. Pat. No. 9,777,212 entitled Light emitting concrete composition and method of synthesizing light emitting concrete structure; US 2020/0109089 entitled Luminescent concrete composition and product; CN102758496 entitled Method for preparing light-transmitting concrete; and BE822626Q entitled Photoluminescent construction materials comprising resin concrete mixed with activated zinc sulfide. Unfortunately, prior mixtures can suffer from a number of problems or limitations. These include lack of sufficient mechanical strength and suitability for use in construction and building applications and insufficient duration or intensity of emitted light.

Due to the current energy dilemma that the world faces, a new multi-functional luminous concrete and sustainable construction methods using it have become evident.

The inventors explored new formulations and ways to produce self-luminous concrete having superior properties. These new formulations of self-luminous concrete advantageously use locally available materials such as those available in Egypt, North African and the Middle East. The inventors explored compositions and steps for sustainably and economically producing energy saving luminescent concretes which would serve as environmentally friendly light sources where power is limited or unavailable and which provide desirable levels of illumination and have excellent compressive strength.

### BRIEF SUMMARY OF THE INVENTION

An objective of this disclosure is the description of various means for producing a self-luminous concrete, which have advantageous illumination properties, using readily available market constituents. Such a self-luminous concrete traps solar energy during daytime and converts it to visible light when light is scarce at night or in places with little or no ambient illumination.

Light emission was assessed using both optical absorption and light emitting tests. Their results revealed that producing a self-luminous concrete while maintaining excellent compressive strength is feasible. Other aspects of this technology involve building, construction, and architectural materials incorporating the self-luminous concrete and methods for making it. The foregoing paragraphs have been provided by way of general introduction and are not intended to limit the scope of the following claims. The described embodiments, together with further advantages, will be best understood by reference to the following detailed description taken in conjunction with the accompanying drawings.

Embodiments of the invention include but are not limited to the following.
1. A light-emitting concrete composition comprising, consisting essentially of, or consisting of:
   cement, fine aggregates, coarse aggregates, and zinc sulfide,
   wherein the amount of zinc sulfide ranges from 95, 100, 110, 120, 130, 140, 150, 160, 170, 180, 190 to 200 kg/m³, and
   wherein the concrete mixture has a water: cement ratio ranging from 0.40, 0.45, 0.50, 0.55, 0.60, 0.65, to 0.70.
2. The light-emitting concrete composition of embodiment 1 that comprises:
   345 kg/m³ of cement,
   600 kg/m³ fine aggregates which have an average diameter no more than 9.55 mm,
   1150 kg/m³ of coarse aggregates,
   121 kg/m³ of zinc sulfide, and
   190 kg/m³ water;
   wherein said concrete mixture has a water: cement (w/c) ratio of 0.45 to 0.60; and
   wherein content of each of the ingredients may vary by ±1, 2, 5, 10, 15 or 20% of the values above.
3. The method of embodiment 1 or 2, wherein the cement comprises ordinary (Type I), modified (Type II), high-early-strength (Type III), low-heat (Type IV), and sulfate-resistant (Type V) as defined by the American Society for Testing and Materials (ASTM), wherein the cement comprises ordinary (Type I), modified (Type II), high-early-strength (Type III), low-heat (Type IV), and sulfate-resistant (Type V) as defined by the American Society for Testing and Materials (ASTM).
4. The light-emitting concrete composition of embodiment 1, 2 or 3, wherein the cement comprises ordinary Portland Cement that contains 60-67 wt % lime, CaO, 17-25 wt % silica, SiO², 3-8 wt % alumina, Al₂O₃, and 0.5-6.0 wt % iron oxide, Fe₂O₃ or any intermediate value of subrange of the above ranges.
5. The light-emitting concrete composition of any one of embodiments 1-4, wherein the coarse aggregates comprise gravel, ground limestone, ground stone, or a combination thereof; wherein the coarse aggregates have an average diameter or size of 9.5 mm or more.
6. The light-emitting concrete composition of any one of embodiments 1-5, wherein the coarse and/or fine aggregates are sourced from Egypt.
7. The light-emitting concrete composition of any one of embodiments 1-6, wherein the fine aggregates comprise natural sand, manufactured sand, iron silicate, granite stone, quartz sillimanite, crystalline silica, recycled glass, crumb rubber, mine tailings, crushed concrete, recycled plastics or a combination thereof; wherein the fine aggregates have an average diameter or size of less than 9.5 mm.
8. The light-emitting concrete composition of any one of embodiments 1-7, wherein the ZnS passes through a sieve having a mesh size of 200.
9. The light-emitting concrete composition of any one of embodiments 1-8, wherein the ZnS is not doped.
10. The light-emitting concrete composition of any one of embodiments 1-9, further comprising at least one dopant for the zinc sulfide that increases, changes the emission color of, or otherwise modifies the emission properties of luminescence from the zinc sulfide.
11. The light-emitting concrete composition of any one of embodiments 1-10, wherein the ZnS is doped with at least one of Ni, Mn, Fe, Co, Cu, Ce, Au, Sr, or Cd.
12. The light-emitting concrete composition of any one of embodiments 1-11 that has a compressive strength after at least 7, 14, 21 or 28 days of at least 20, 30 or 40 MPa.
13. The light-emitting concrete composition embodiment 1 that has a compressive strength after at least 7, 14, 21 or 28 days of at least 40 MPa.
14. The light-emitting concrete composition of any one of embodiments 1-13 that has an intensity of glow of 1, 2, 3, 4 or 5 candela per M² for 100 min or more.
15. The light-emitting concrete composition of any one of embodiments 1-14 that has an intensity of glow of 1, 2, 3, 4 or 5 candela per M² for 200 min or more.
16. The light-emitting concrete composition of any one of embodiments 1-15 that has a compressive strength of 27-33 MPa, absorbs light having a wavelength ranging from 240-250 nm, has an absorption of 0.60 AU, emits light of a wavelength between 470 and 600, or emits light at an intensity of 25,000, 29,000 to 32,000 CNT. In some embodiments the light-emitting concrete will maintain at least 10, 20, 30, 40, or 50% of its intensity after 1, 2, 3, 4, 5 or >5 years.
17. The light-emitting concrete composition of any one of embodiments 1-16 in a solid cured or hardened form.
18. The light-emitting concrete composition of any one of embodiments 1-17 in an uncured liquid or semisolid form.
19. The light-emitting concrete composition of any one of embodiments 1-18 that further comprises at least one water-reducing agent, accelerating agent, retarding agent, shrinkage reducing agent, set retarding agent, viscosity modifying agent, air entraining agent, superplasticizer, resin, corrosion inhibitor, phosphorescent pigment, sulfide other than ZnS, reflective material, glass, mica or metallic flakes, or coloring.
20. The light-emitting concrete composition of any one of embodiments 1-19 that further comprises a reinforcing material.
21. The light-emitting concrete composition of any one of embodiments 1-20 that further comprises reinforcing material that is steel, glass fiber reinforced polymer, carbon fiber reinforced polymer, plastic or aluminum.
22. The light-emitting concrete composition of any one of embodiments 1-21 in a form of a building or architectural material.
23. The light-emitting concrete composition of any one of embodiments 1-22 in a form of a building or architectural material that comprises wall, column or structural support, or foundation.
24. The light-emitting concrete composition of any one of embodiments 1-23 in a form of a building or architectural material that comprises brick, block or paver.
25. The light-emitting concrete composition of any one of embodiments 1-24 in a form of a building or architectural material that comprises mortar or a concrete coating.
26. A method for making the light-emitting concrete of any one of embodiments 1-25 comprising:
   admixing in any order the cement, coarse aggregates, fine aggregates, zinc sulfide and water to produce a slurry,
   filling a void, molding, or coating a surface with the slurry,
   curing the slurry at a temperature of 15-30° C. or keeping the surface of the curing slurry moist.
27. A concrete dry mix comprising:
   345 kg/m³ of cement,
   600 kg/m³ fine aggregates which have an average diameter no more than 9.55 mm,
   1150 kg/m³ of coarse aggregates, and
   121 kg/m³ of zinc sulfide,
   wherein content of each of the ingredients may vary by ±20% of the values above.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings below.

FIG. 1 describes the inventors' general testing schemes for evaluation of the luminescent concretes of the invention including light testing (absorption and emission), fresh concrete testing, and hardened concrete testing including determination of compressive strength of a luminescent concrete.

FIG. 2 depicts components of luminescent concretes produced and tested by the inventors. The lead mix does not include the resin ingredient.

FIG. 3A describes results from a control concrete and three light-emitting concretes. The lead mix in FIGS. 3A and 3B is called Mix III (35% ZnS); in FIG. 4 it is Mix V (35% ZnS).

FIG. 3B compares the compressive strength, optical absorption, and light emission results for the 15 and 35% commercial zinc sulphide (ZnS) mixtures with a control mix. All materials described in FIGS. 3A and 3B were sourced from Egypt.

FIG. 4 visually describes the appearance of concretes produced by Mixes II-VII in light and in darkness and depicts strength testing and provides the compressive strength results after 3, 7 or 28 days. Solid cubes that contained the luminescent materials throughout the cube, not merely on its surface, were tested.

FIG. 5A compares the compressive strength of the concretes produced from Mixes II-VII at 28 days.

FIGS. 5B and 5C show the emission spectra (wavelength) of commercial zinc sulfide and glow aggregates.

FIG. 6 shows the slump test, temperature results and air content of concretes made from Mixes II-VII.

FIGS. 7A and 7B illustrate a sample for a cube made before light absorption at the first stage (FIG. 7A) and at the stage of emission afterwards (FIG. 7B) which show the visible emission of light in the tested sample.

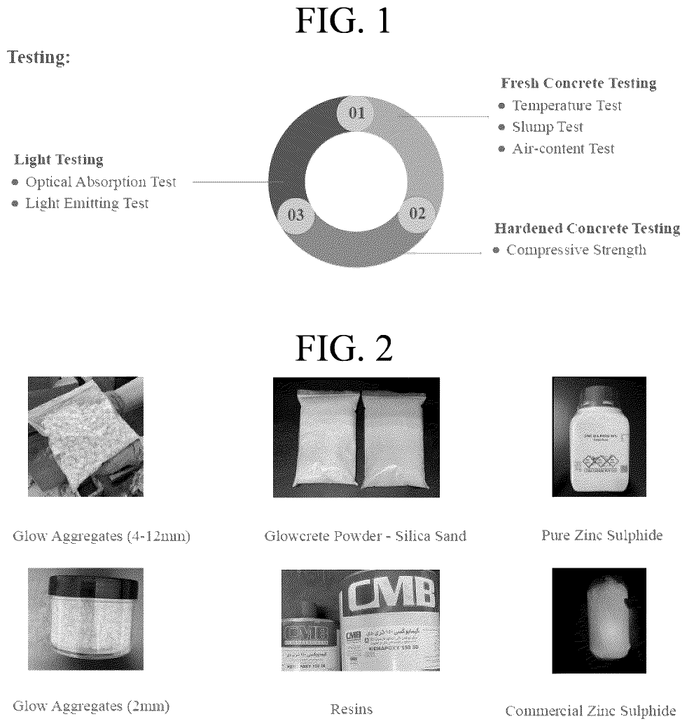

### DETAILED DESCRIPTION OF THE INVENTION

Due to the current energy dilemma that the world faces, a new multi-functional and sustainable method of construction like self-luminous concrete became evident. In addition, over the past five decades, a quantum leap has taken place in the concrete industry through the incorporation of various constituents and new advances in concrete technology and manufacturing techniques. Changing the aesthetics of concrete has been studied as well through various approaches and mechanisms to alter its opaque grey exterior. Such efforts were exerted not only to make concrete more appealing, but also to take it a step closer to being more environmentally friendly. So, self-luminous concrete is a type of concrete that has the ability to trap light energy when subjected to a light source and later emit it when it becomes dark. With the current energy challenges facing the world as a result of over-reliance on non-renewable energy resources, creating means to save energy and develop a gradual shift to renewable energy have become most crucial. Along these same lines, light emitting concrete has an excellent potential to decrease the need to install electrically powered lights on highways, roads, runways, bicycle paths, docks, and walkways. In view of the above, the inventors explored different ways to economically produce self-luminous concrete having excellent illuminating properties and strength using ingredients that are readily available.

As shown herein, the inventors' efforts lead to the development of self-luminous concrete that has several distinguishing features that set it apart from other types of luminescent concrete, which are:

It has zinc sulphide (ZnS), unlike previous concrete mixes, which contributes to the concrete's enhanced light-emitting properties.

All materials can be locally sourced (aggregates, cement, sand, and even zinc sulphide), which reduces transportation costs and environmental impact, making the concrete more sustainable and cost-effective. Moreover, waste or recycled materials, such as crushed glass. plastics, or other building materials such as concrete may be incorporated into the compositions disclosed herein.

Along with having luminescent properties, the concrete has adequate mechanical properties for concrete, such as compressive strength, which makes it withstand structural loads and stresses while still providing luminescent properties. Example 3 below describes the results of the compressive strength tests, light emission tests, and optical absorption tests.

### Invention Terminology

Concrete is a widely used construction material known for its durability and versatility. Concrete is typically exceptionally strong in bearing compressive forces or loads and can absorb and dissipate energy from dynamic loads that occur in roadways, bridges, and industrial flooring where vibration and impacts occur. Concrete can withstand thermal stress from moderate temperature variations without significant expansion or contraction. Concrete may be formulated to withstand hydraulic pressure, such as that from a dam, reservoir or canal, often in combination with waterproofing. Concrete may also be formulated for applications that expose it to chemicals, such as in chemical storage tanks or waste-water processing facilities. Concrete generally comprises several components mixed together in specific proportions to create a solid, strong and cohesive material. Common ingredients include cement, coarse and fine aggregates, water and admixtures. For some applications concrete is reinforced with metals, for example, with steel rebar.

Concrete mixture or concrete composition as described herein refers to uncured, partially cured, or cured concrete made from recited ingredients when mixed together. A concrete mixture may be cured for 1, 2, 3, 4, 5, 6, 7, 14, 21, 28 or >28 days or any intermediate value within this range. A concrete mixture or composition encompass a mixture of the ingredients as well as the ingredients after hydration a chemical reaction in which the major compounds in cement form chemical bonds with water molecules and become hydrates or hydration products. As disclosed herein, a concrete mixture or composition may be produced by coating a surface with the light-absorbing and emitting concrete or substance; it may be produced by modifying the microstructure of the concrete itself by treating the microstructure of the cement itself to establish light-emitting property within it; or it may be attained by an in-mix modification of the concrete mixture. Advantageously many embodiments described herein use an in-mix modification of the concrete mixture or composition by addition of ZnS or another phosphorescent or luminous pigment.

Curing. A concrete mixture may be cured under specific temperature (e.g., <15, 15, 20, 25, 30, 35, 40 or >30° C., preferably at about 20-25° C.) and moisture conditions (e.g., moist curing, pond curing, hot mixing, electrical curing, infra-red curing, wet covering, covering with sand, sawdust or soil, membrane curing, or curing with a curing compound.

Cement is a fine powder that serves as a primary binding agent in concrete. Advantageously, the light-emitting concretes disclosed herein may contain a Portland cement. Cements include regular Portland cement, which is made from limestone, clay and other minerals heated to high temperatures and then ground to a fine powder. Portland cement reacts with water to form a paste that binds the other ingredients in some concrete together. Other cements include Portland Pozzolana cement (PPC), which incorporates fly ash, volcanic ash or silica fume into ordinary Portland cement; rapid hardening cement (high early strength cement) used for road repairs and precaste concrete products where high strength and short curing time is required; Portland slag cement (PSC) which incorporates granulated blast furnace slag which is resistant to chemical attack and used in marine or coastal construction; white cement, which is made from materials with a low iron content and having a white or off-white color often used to make colored concrete, terrazzo flooring, and for architectural details. An ordinary Portland Cement may contain 60-67 wt. % lime, CaO, 17-25 wt % silica, SiO₂, 3-8 wt. % alumina, Al₂O₃, and 0.5-6.0 wt. % iron oxide, Fe₂O₃. A typical Portland cement contains by weight 50 wt % tricalcium silicate, 25 wt. % dicalcium silicate, 10 wt. % tricalcium aluminate, 10% tetracalcium aluminoferrite and 5 wt. % gypsum, wherein the content of one or more ingredients may vary by 1, 2, 5, 10 or 20 wt. %.

Coarse Aggregates comprise granular materials that usually make up the bulk of the concrete volume. Examples include gravel, crushed gravel, crushed stone, recycled concrete aggregate (RCA);and crushed slag aggregates derived from production of iron and steel, which can increase the density and durability of a concrete. Selection of properly cleaned and graded coarse aggregates is important for production of a strong and versatile concrete.

Fine Aggregates comprise sand and other small particles that can fill the gaps between the larger coarse aggregates. These also include crushed stone dust, manufactured fine aggregates obtained from crushed and screened rock or stone and which can be selected to have particular particle sizes and shapes; crushed gravel or recycled concrete. Fine aggregates play an important role in determining the properties and performance of a concrete.

Coarse and fine aggregates may comprise vermiculite, perlite, ceramic spheres for production of ultra-light weight concrete; expanded clay, shale or slate, crushed brick for lightweight concrete; crushed limestone, sand, river gravel, crushed recycled concrete for normal weight concrete; or steel or iron shote, steel or iron pellets for heavyweight concrete.

Other ingredients (admixtures) are added to concrete, such as the zinc sulfide disclosed herein, to modify its functional properties. In the context of the present disclosure, these are usually optional ingredients other than ZnS that can be included in a concrete to modify its properties and include superplasticizers to reduce water content of an uncured concrete while maintaining flowability, air-entraining ingredients to produce a concrete incorporate small air bubbles to insulate against temperature fluctuations, accelerators or retardants to speed up or slow down concrete curing, coloring agents, and dopants, for example, for phosphorescent ingredients such as ZnS.

Zinc Sulfide (Zinc Sulphide) is a phosphorescent pigment that absorbs and stores light energy when exposed to light and then slowly releases visible light over an extended period. In some alternatively embodiments, other phosphorescent pigments or materials, such as strontium aluminate, may be used alone or in combination with zinc sulfide. Typically ZnS in a crystalline form is used in the concrete disclosed herein. Such crystalline forms include cubic zinc blend, wurtzite structure, and doped crystalline ZnS. ZnS crystal sizes may range from 1, 2, 10, 20, 50 to 100, 200, 500 and <1,000 nm; or 1, 2, 5, 10, 20, 50 μm or more. Smaller sized ZnS crystals usually produce a more uniform glow than larger crystals when incorporated into concrete.

Dopants for Zinc Sulfide. The concretes disclosed herein may, optionally, incorporated doped ZnS or undoped ZnS. Dopants include copper, silver, terbium, and/or lithium. ZnS doped with copper emits visible greenish light when exposed to X-rays. ZnS doped with silver emits visible blue or violet light when exposed to X-rays. ZnS doped with terbium emits visible green or yellow-green light when exposed to X-rays. ZnS doped with lithium emits visible light when exposed to X-rays. Doped ZnS may contain 1, 2, 5, 10, 20, 50, 100, 200, 500, 1000, 2000, 5000, 10,000, 20,000, or 50,000 ppm (by weight) copper, silver, terbium and lithium depending on the desired color, intensity and duration of phosphorescence. The value 10,000 ppm (by weight) equals 1 wt. %.

Water. Typically potable water is used to formulate a concrete because it meets safety and quality standards and requires little or no purification or processing. In some cases, non-potable water, rainwater, brackish water, or sea water may be used to formulate concrete in areas with limited access to clean water or for special projects. However, in these cases it is important to evaluate water quality and implement measures to avoid corrosion of reinforcing materials such as rebar and to avoid harmful or toxic components that affect concrete quality and safety. For formulating concretes for comparison or testing, distilled or deionized water may be used to formulate the concrete.

Concrete ingredients historically, locally and economically available in Egypt, North Africa and the Middle East. The main components necessary for producing the luminescent concretes disclosed herein are readily available in Egypt. These include Portland cement used to bind the other concrete ingredients together, see The History of Concrete, Gromicko, N., CMI, & Shepard, K. <www.nachi.org/history-of-concrete.htm> last accessed Oct. 6, 2023, incorporated by reference.

Egyptian Cornstalk ash or El Moukawem 42.5R (sulfate resistant cement), Al Fanar Cement Type II, El Saeed Cement, El Mohandes Cement, El Derea, Assiut Poralnd Pozzolanic Cement, and Al Primo mortar are available in Egypt and the Middle East and may be used as cement ingredients in concretes disclosed herein; see <https://www.cemex.com.eg/products/cement/cement-products>, last accessed Oct. 6, 2023, incorporated by reference. Other local ingredients include crushed limestone, crushed dolomite, and recycled aggregates, which may be admixed with limestone, and demolished concrete as coarse aggregates; and fine sand such as Beir El-bd sand, granite dust, and Egyptian serpentine including antigorite and lizardite as fine aggregates. One or more of these ingredients may be incorporated into a luminescent concrete as disclosed herein.

Resins may be absent or excluded from the light-emitting concretes of the invention or in some embodiments are added to improve the functionality and performance of the concrete, for example, in amounts ranging from <1, 1, 2, 5, 10, 15, 20, 25, 30 or >30 wt % based on the total weight of the concrete composition. Resins include, but are not limited to furan, furan epoxide, polyester, maleic polyester, acrylate polyester, epoxide, phenol formaldehyde, acetone formaldehyde, carbamide, acrylic resin, vinyl monomers, acrylate and methacrylate based binders, vinyl esters, monomers of vinyl series, polyurethane, epoxy resins, epoxy-polyaniline combination, furan epoxy combination (FAED) or combination thereof.

Superplasticizers are used to reduce the water content of a concrete while maintaining workability or the ease at which a fresh concrete can be mixed, placed, consolidated, and finished with a minimum loss of homogeneity. In some embodiments, a fresh concrete produced using the components disclosed herein can include a superplasticizer, such as Superplasticizers 1, 2, 5, 7 or Melflux. In other embodiments, the light-emitting concretes disclosed herein exclude or omit superplasticizers.

Concrete reinforcements include iron or steel rebar, steel, glass or synthetic fibers, wire mesh, welded wire fabric, fiber-reinforced polymer bars, bamboo, basalt rebar especially in places were metal may corrode, glass fiber reinforced bars, carbon fiber reinforced strips, geogrids, or high strength steel cables for post-tensioning.

Tests used to characterize the luminous concrete included:

Energy Dispersive x-ray (EDX): This test is conducted to determine the composition of the used materials.

Temperature: This test was conducted to ensure the concrete's conformity with temperature requirements with no excessive heat.

Slump: This test was conducted to check the consistency/workability of the fresh concrete.

Air Content: This test was conducted to determine the air content of the concrete.

Compressive Strength: This test was conducted to evaluate the concrete's strength using 150 mm cubes according to British standards. Samples were tested at 3, 7, and 28 days.

Optical Absorption: This test was conducted by a UV-visible spectrophotometer to determine the photoactivity of the material and its wavelength (λ) by measuring the intensity of light as a beam of light passes through the sample. Light Emitting:

This test was conducted by lumina spectrophotometer to determine the material's ability to emit light during the excitation of the electron and its intensity which occurs when light of specific wavelength hits and excites electrons in a sample, and the electrons in that sample instantly emit light of a different wavelength.

### EMBODIMENTS

The invention includes but is not limited to the following embodiments.

A light-emitting concrete composition comprising, consisting essentially of, or consisting of cement, fine aggregates, coarse aggregates, and zinc sulfide, wherein the amount of zinc sulfide ranges from 95-150 kg/m³, and wherein the concrete mixture has a water: cement ratio ranging from 0.45. 0.5, 0.55 to 0.60 or any intermediate value or subrange.

In some embodiments, the light-emitting concrete composition of described above comprises 345 kg/m³ of cement, 600 kg/m³ fine aggregates which have an average diameter no more than 9.55 mm, 1150 kg/m³ of coarse aggregates, 121 kg/m³ of zinc sulfide, and 190 kg/m³ water; wherein said concrete mixture has a water: cement (w/c) ratio of 0.45, 0.50, 0.55 to 0.60; and wherein content of each of the ingredients may vary by ±1, 2, 5, 10, 15, or 20% of the values above.

In some embodiments, the cement used in the concrete described above comprises ordinary (Type I), modified (Type II), high-early-strength (Type III), low-heat (Type IV), and sulfate-resistant (Type V) as defined by the American Society for Testing and Materials (ASTM), wherein the cement comprises ordinary (Type I), modified (Type II), high-early-strength (Type III), low-heat (Type IV), and sulfate-resistant (Type V) as defined by the American Society for Testing and Materials (ASTM).

In another embodiment, in the light-emitting concrete composition above the cement comprises ordinary Portland Cement that contains 60-67 wt % lime, CaO, 17-25 wt % silica, SiO², 3-8 wt % alumina, Al₂O₃, and 0.5-6.0 wt % iron oxide, Fe₂O₃.

In some embodiments the coarse aggregates used in the light-emitting concrete comprise gravel, ground limestone, ground stone, or a combination thereof; wherein the coarse aggregates have an average diameter or size of 9.5, 10, 15, 20, 30, 40 or more.

In some advantageous embodiments, in the light-emitting concrete composition described the coarse and/or fine aggregates are sourced from Egypt, North Africa or the Middle East.

In some embodiments the fine aggregates in the light-emitting concrete comprise natural sand, manufactured sand, iron silicate, granite stone, quartz sillimanite, crystalline silica, recycled glass, crumb rubber, mine tailings, crushed concrete, recycled plastics or a combination thereof; wherein the fine aggregates have an average diameter or size of less than 7.0, 7.5, 8.0, 8.5, 9.0 or 9.5 mm.

In certain embodiments of the light-emitting concrete disclosed herein, the ZnS component passes through a sieve having a mesh size of 100, 150, 200, 250, or 300.

In some embodiments, the light-emitting concrete composition contains a ZnS component that is not doped.

In other embodiments, the ZnS component has at least one dopant that increases, changes the emission color of, or otherwise modifies the emission properties of luminescence from the zinc sulfide. Dopants for ZnS include Ni, Mn, Fe, Co Cu, Ce, Au, Sr, or Cd or combinations thereof

In an advantageous embodiment, the light-emitting concrete composition disclosed herein a compressive strength after 28 days of at least 20, 21, 22, 23, 24, 25, 26, 27, 28, 29, 30, 31, 32, 33, 34, 35, 36, 37, 38, or 39 MPa. In another embodiments, the light-emitting concrete has a compressive strength after 28 days of at least 39, 39.5, 40, 40.5, 41, 42, 43, 44, 45, 46, 47, 48, 49, 50, or >50 MPa.

Advantageously the light-emitting concrete composition disclosed herein has an intensity of glow of 1, 2, 3, 4, 5, 6, 7, 8, 9, 10 or >10 4 candela per M² for 30, 40, 50, 60 70 80, 90, 100, 150, 200, 250, 300 min or more.

In some embodiments, the light-emitting concrete composition disclosed herein has a compressive strength of 27-33 MPa, absorbs light having a wavelength ranging from 240-250 nm, has an absorption of 0.60 AU, emits light of a wavelength between 470 and 600, or emits light at an intensity of 29,000 CNT.

The light-emitting concrete composition disclosed herein may being a solid cured or hardened form or in an uncured liquid, semicured, or semisolid form.

In certain embodiments, the light-emitting composition disclosed herein may further comprise at least one water-reducing agent, accelerating agent, retarding agent, shrinkage reducing agent, set retarding agent, viscosity modifying agent, air entraining agent, superplasticizer, resin, corrosion inhibitor, phosphorescent pigment, sulfides other than ZnS, reflective material, glass, mica or metallic flakes, or coloring.

The light-emitting concrete composition disclosed herein may further comprise a reinforcing material such as steel, glass fiber reinforced polymer, carbon fiber reinforced polymer, plastic or aluminum.

The light-emitting concrete composition disclosed herein may be in the form of a building or architectural material, it may form part of a wall, column or structural support, or foundation, it may form part of building, monument, canal, wharf, loading dock, bike path, pedestrian walkway, highway, highway marker, sign, road, security wall or barrier, or tarmac; it may be in the form of a cube, brick, block, or paver. In one embodiment, it forms part of a mortar or a coating, for example, a skim coating for a wall or floor or walkway or other surface including non-luminous concrete surfaces. The light-emitting concretes disclosed herein may be used to decrease the need to install electrically powered lights on highways, walkways and other access routes or areas.

One aspect of the invention is directed to a method for making the light-emitting concrete of embodiment 1 comprising admixing in any order the cement, coarse aggregates, fine aggregates, zinc sulfide and water to produce a slurry, filling a void, molding, or coating a surface with the slurry, curing the slurry at a suitable temperature or moistness, such as at a temperature of 15, 20, 25, 30, 35, 40, 45, 50, >50° C. Curing may comprise keeping the surface of the curing slurry moist.

Mixing. In producing the concrete mixtures described herein, there is no specified temperature or moist condition required during mixing. Such conditions may be selected by those skilled in the art. The mixing process may comprise the following steps:

All the dry ingredients (cement, aggregates, and sand) are combined in a concrete mixer and mix thoroughly then the luminescent material is added and make sure that all the materials are evenly distributed throughout the mixture.

Water is gradually added to the dry mix while continuing to mix.

Mixing is continued until a homogeneous, workable mixture is attained.

The resulting mixture is poured or cast to form cubes (or other shapes or surfaces) which are then cured. For cubes, the poured cubes are cured in a closed room and water is splashed on the cubes.

Another aspect of this disclosure is directed to concrete dry mix comprising: 345 kg/m³ of cement, 600 kg/m³ fine aggregates which have an average diameter no more than 9.55 mm, 1150 kg/m³ of coarse aggregates, and 121 kg/m³ of zinc sulfide, wherein content of each of the ingredients may vary by ±20% of the values above.

### Example 1

### Formulation of Luminescent Concretes (Cubes)

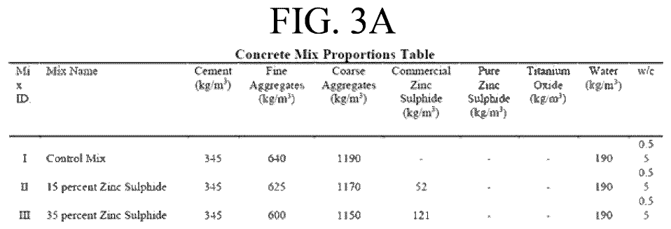

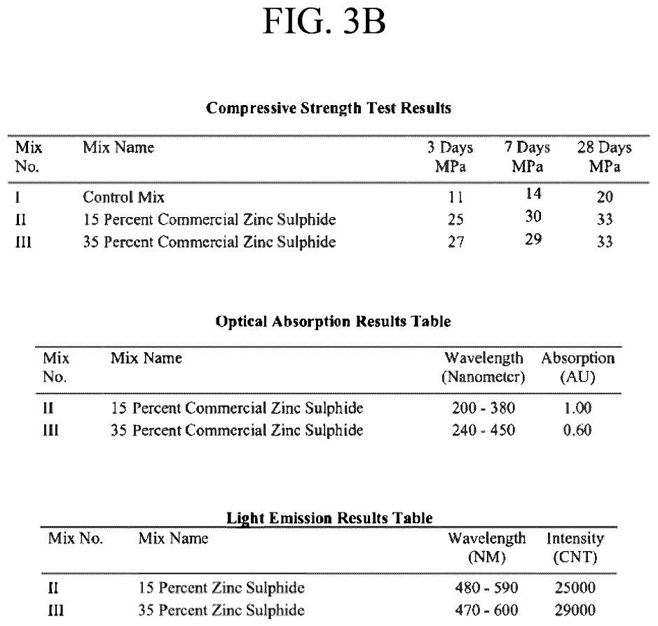

Mixes I through VII as described by FIG. 3 were prepared. Glow aggregates having particle sizes ranging from 4-12 mm are commercially available and glow aggregates having an average particle size of about 2 mm were obtained. Glowcrete powder was obtained from a commercial source. Silica sand a fine aggregate was obtained from a commercial source as was pure (100%) zinc sulfide (sulphide) and pure (15% or 35%) zinc sulfide (ZnS).

The resulting slurries were poured into concrete block molds and cured at 25° C. for 3, 7 and 28 days. Curing concrete blocks were kept moist.

### Example 2

### Luminance Testing

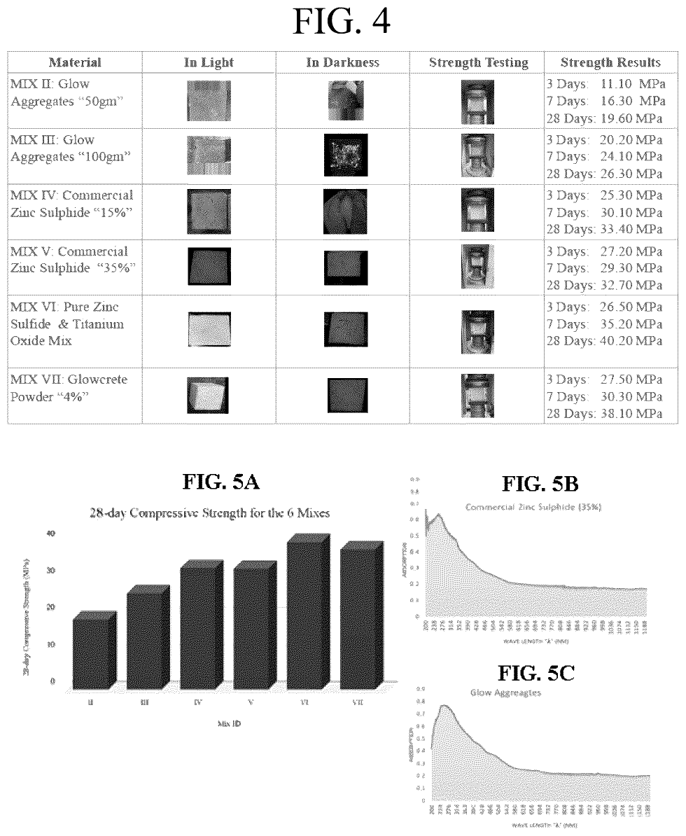

Luminosity of blocks produced from Mixes I-VII in Example 1 was visually assessed in light and in darkness at 28 days. Results are reported in FIG. 4 and show that Mix III (containing Glow Aggregates and Mix V formulated with 35% ZnS had excellent luminosity in the dark. FIGS. 7A and 7B show the luminosity of the blocks prepared with Mix V.

A light measuring photometer is used to evaluate the intensity and duration of light in candelas per meter squared (cd/m₂) emitted from the cured concrete blocks described in Example 1. The blocks are placed in a dark box for 24 hrs prior to eradicate any excitation from external light sources then are charged by exposure to a 150 Watt xenon lamp.

### Example 3

### Measurement of Compressive Strengths of Luminescent Concretes

Results of Compressive strength testing for Mixes II-VII appear in FIG. 4 and in FIG. 5A.

FIGS. 5B and 5C compare the emission wavelengths of 35% ZnS (Mix 5) and Glow Aggregates (Mixes II and III).

Concrete mix proportions for Mix V and results for compressive strength, light emission, and optical absorption for Mix 5 are summarized below.

CONCRETE MIX PROPORTIONS
For 1 m³, the mix proportions were as follows:

| Components | Quantities |
|---|---|
| Cement (kg/m³) | 345 |
| Fine Aggregates (kg/m³) | 600 |
| Coarse Aggregates (kg/m³) | 1150 |
| Zine Sulphide (kg/m³) | 121 |
| Water (kg/m³) | 190 |
| w/c | 0.55 |

STRENGTH AND DURABILITY
1. Compressive Strength Test Results

| | 3 Days | 7 Days | 28 Days |
|---|---|---|---|
| Mix Name | (MPa) | (MPa) | (MPa) |
| Zinc Sulphide | 27 | 29 | 33 |

2. Light Emission Test Results

| Mix Name | Wavelength (NM) | Intensity (CNT) |
|---|---|---|
| Zinc Sulphide | 470-600 | 29000 |

3. Optical Absorption Test Results

| Mix Name | Wavelength (Nanometer) | Absorption (AU) |
|---|---|---|
| Zinc Sulphide | 240-450 | 0.60 |

### Example 4

### Measurement of Fresh Concrete Characteristics of Luminescent Concretes

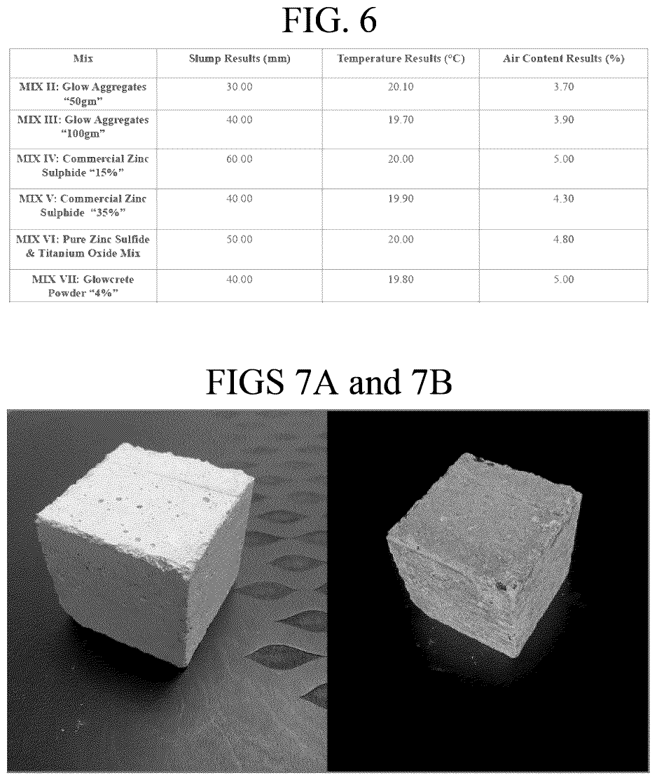

The concrete compositions of Mixes II-VII were subjected to slump testing, evaluated for temperature, and air content. Results are shown in FIG. 6.

Terminology. Terminology used herein is for the purpose of describing particular embodiments only and is not intended to be limiting of the invention.

Unless expressly stated, the terms used herein are intended to have the plain and ordinary meaning as understood by those of ordinary skill in the art.

The following definitions are intended to aid the reader in understanding the present disclosure but are not intended to vary or otherwise limit the meaning of such terms unless specifically indicated.

While aspects of the present disclosure have been described in conjunction with the specific embodiments thereof that are proposed as examples, alternatives, modifications, and variations to the examples may be made. The description and specific examples, while indicating embodiments of the technology, are intended for purposes of illustration only and are not intended to limit the scope of the technology. Moreover, recitation of multiple embodiments having stated features is not intended to exclude other embodiments having additional features, or other embodiments incorporating different combinations of the stated features. Specific examples are provided for illustrative purposes of how to make and use the compositions and methods of this technology and, unless explicitly stated otherwise, are not intended to be a representation that given embodiments of this technology have, or have not, been made or tested.

As used herein, the words “preferred” and “preferably” refer to embodiments of the technology that afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the technology.

It should be noted that, as used in the specification and the appended embodiments, the singular forms “a,” “an,” and “the” include plural referents unless the context clearly dictates otherwise. See Harari v. Lee, 656 F.3d 1331, 1341, (Fed. Cir. 2011); Baldwin Graphic Sys., Inc. v. Siebert, Inc., 512 F.3d 1338, 1342 (Fed. Cir. 2008)); KJC Corp. v. Kinetic Concepts, Inc., 223 F.3d 1351, 1356 (Fed. Cir. 2000).

As used herein, the term “and/or” includes any and all combinations of one or more of the associated listed items and may be abbreviated as “/”. A and/or B includes A, B, and (A+B).

As used herein in the specification, including as used in the examples and unless otherwise expressly specified, all numbers may be read as if prefaced by the word “substantially”, “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−0.2% of the stated value (or range of values), +/−0.5% of the stated value (or range of values), +/−1% of the stated value (or range of values), +/−2% of the stated value (or range of values), +/−5% of the stated value (or range of values), +/−10% of the stated value (or range of values), +/−15% of the stated value (or range of values), +/−20% of the stated value (or range of values), etc. Any numerical range recited herein is intended to include all sub-ranges and values subsumed therein.

Any numerical range recited herein is intended to include all sub-ranges and values subsumed therein. Where a range of values is provided, it is to be understood that each intervening value between an upper and lower limit of the range and any other stated or intervening value in that stated range is encompassed within the disclosure. Where the stated range includes upper and lower limits, ranges excluding either of those limits are also included.

Disclosure of values and ranges of values for specific parameters (such as temperatures, molecular weights, weight percentages, etc.) are not exclusive of other values and ranges of values useful herein. It is envisioned that two or more specific exemplified values for a given parameter may define endpoints for a range of values that may be embodied for the parameter. For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be embodimented using endpoints of the disclosed ranges. For example, if parameter X is exemplified herein to have values in the range of 1-10 it also describes subranges for Parameter X including 1-2, 1-3, 1-4, 1-5, 1-6, 1-7, 1-8, 1-9, 2-3, 2-4, 2-5, 2-6, 2-7, 2-8, 2-9, 2-10, 3-4, 3-5, 3-6, 3-7, 3-8, 3-9, 3-10, 4-5, 4-6, 4-7, 4-8, 4-9, 4-10, 5-6, 5-7, 5- 8, 5-9, 5-10, 6-7, 6-8, 6-9, 6-10, 7-8, 7-9, 7-10, 8-9, 8-10, 9-10 as some examples. A range encompasses its endpoints as well as values inside of an endpoint, for example, the range 0-5 includes 0, >0, 1, 2, 3, 4, <5 and 5.

As referred to herein, all compositional percentages are by weight of the total composition, unless otherwise specified. As used herein, the word “include,” and its variants, is intended to be non-limiting, such that recitation of items in a list is not to the exclusion of other like items that may also be useful in the materials, compositions, devices, and methods of this technology. Similarly, the terms “can” and “may” and their variants are intended to be non-limiting, such that recitation that an embodiment can or may comprise certain elements or features does not exclude other embodiments of the present invention that do not contain those elements or features.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

Spatially relative terms, such as “under”, “below”, “lower”, “over”, “upper”, “in front of” or “behind” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

All publications and patent applications mentioned in this specification are herein incorporated by reference in their entirety to the same extent as if each individual publication or patent application was specifically and individually indicated to be incorporated by reference, especially referenced is disclosure appearing in the same sentence, paragraph, page or section of the specification in which the incorporation by reference appears.

The citation of references herein does not constitute an admission that those references are prior art or have any relevance to the patentability of the technology disclosed herein. Any discussion of the content of references cited is intended merely to provide a general summary of assertions made by the authors of the references and does not constitute an admission as to the accuracy of the content of such references.

1. A light-emitting concrete composition comprising:
cement, fine aggregates, coarse aggregates, and zinc sulfide;
wherein the amount of zinc sulfide ranges from 95-150 kg/m³, and
wherein the concrete mixture has a water: cement ratio ranging from 0.45 to 0.60.

2. The light-emitting concrete composition of claim 1 that comprises:
345 kg/m³ of cement,
600 kg/m³ fine aggregates which have an average diameter no more than 9.55 mm,
1150 kg/m³ of coarse aggregates,
121 kg/m³ of zinc sulfide, and
190 kg/m³ water;
wherein said concrete mixture has a water: cement (w/c) ratio of 0.45 to 0.60; and
wherein content of each of the ingredients may vary by ±20% of the values above.

3. The light-emitting concrete composition claim 1, wherein the cement comprises ordinary Portland Cement that contains 60-67 wt % lime, CaO, 17-25 wt % silica, SiO², 3-8 wt % alumina, Al₂O₃, and 0.5-6.0 wt % iron oxide, Fe₂O₃.

4. The light-emitting concrete composition claim 1, wherein the coarse aggregates comprise gravel, ground limestone, ground stone, or a combination thereof; wherein the coarse aggregates have an average diameter or size of 9.5 mm or more.

5. The light-emitting concrete composition claim 1, wherein the coarse and/or fine aggregates are sourced from Egypt.

6. The light-emitting concrete composition claim 1, wherein the fine aggregates comprise natural sand, manufactured sand, iron silicate, granite stone, quartz sillimanite, crystalline silica, recycled glass, crumb rubber, mine tailings, crushed concrete, recycled plastics or a combination thereof; and wherein the fine aggregates have an average diameter or size of less than 9.5 mm.

7. The light-emitting concrete composition claim 1, wherein the ZnS passes through a sieve having a mesh size of 200.

8. The light-emitting concrete composition claim 1, wherein the ZnS is not doped.

9. The light-emitting concrete composition claim 1, further comprising at least one dopant for the zinc sulfide that increases, changes the emission color of, or otherwise modifies the emission properties of luminescence from the zinc sulfide.

10. The light-emitting concrete composition claim 1, wherein the ZnS is doped with Ni, Mn, Fe, Co, Cu, Ce, Au, Sr, or Cd.

11. The light-emitting concrete composition claim 1 that has a compressive strength after 28 days of at least 30 MPa.

12. The light-emitting concrete composition claim 1 that has a compressive strength after 28 days of at least 40 MPa.

13. The light-emitting concrete composition claim 1 that has an intensity of glow of at least 4 candela per M² for 100 min or more.

14. The light-emitting concrete composition claim 1 that has a compressive strength of 27-33 MPa, absorbs light having a wavelength ranging from 240-250 nm, has an absorption of 0.60 AU, emits light of a wavelength between 470 and 600, or emits light at an intensity of at least 29,000 CNT.

15. The light-emitting concrete composition of claim 1 in a solid cured, dried or hardened form.

16. The light-emitting concrete composition of claim 1 in an uncured liquid, slurry, or semisolid form.

17. The light-emitting concrete composition of claim 1 that further comprises at least one water-reducing agent, accelerating agent, retarding agent, shrinkage reducing agent, set retarding agent, viscosity modifying agent, air entraining agent, superplasticizer, resin, corrosion inhibitor, phosphorescent pigment, sulfide other than ZnS, reflective material, glass, mica or metallic flakes, or coloring.

18. The light-emitting concrete composition of claim 1 that further comprises a reinforcing material.

19. A method for making the light-emitting concrete of claim 1 comprising:
admixing in any order the cement, coarse aggregates, fine aggregates, zinc sulfide and water to produce a slurry,
filling a void, molding, or coating a surface with the slurry,
curing the slurry at a temperature of 15-30° C. or keeping the surface of the curing slurry moist.

20. A concrete dry mix comprising:
345 kg/m³ of cement,
600 kg/m³ fine aggregates which have an average diameter no more than 9.55 mm,
1150 kg/m³ of coarse aggregates, and
121 kg/m³ of zinc sulfide,
wherein content of each of the ingredients may vary by ±20% of the values above.
